(19) United States
(12) Patent Application Publication
(10) Pub. No.: US 2007/0283551 A1
(43) Pub. Date: Dec. 13, 2007

(54) Method for fabricating ceiling fan blade

(76) Inventor: Yu-Keng Huang, Tucheng City (TW)

Correspondence Address: TROXELL LAW OFFICE PLLC;SUITE 1404, 5205 LEESBURG PIKE, FALLS CHURCH, VA, 22041, US

(21) Appl. No.: 11/449,716

(22) Filed: Jun. 9, 2006

(51) Int. Cl. B23P 25/00

(52) U.S. Cl. 29/458

(57) ABSTRACT

A method for fabricating ceiling fan blade includes steps of: a) punching: choosing a film and then punching at least four positioning holes on the film; b) printing: printing a certain pattern on the film; c) drying: drying the film with infrared to form a film carrier; d) cutting: cutting the film carrier in accordance with desired sizes and shapes; e) shaping: placing the cut film carrier in an injection mold, and injection-shaping a shrouding block on a surface of the cut film carrier, the shrouding block enveloping a peripheral of the cut film carrier; f) cooling: cooling the shaped film carrier and forming a ceiling fan blade. The method for fabricating ceiling fan blade raises yield rate and reduces labor cost. The fabricated ceiling fan blades take on diverse colors, and are novel, beautiful, bright and glazed.

### BACKGROUND OF THE INVENTION

(a) Field of the Invention

The present invention relates to a method for fabricating ceiling fan blade, and particularly to a method for fabricating ceiling fan blade which lifts yield rate and reduces labor cost and which produces bright and colorful ceiling fan blades.

(b) Description of the Prior Art

In prior art, ceiling fan blades are generally injection-shaped of plastic with certain sizes and shapes at first. Then certain patterns and grains are printed by heat or UV lacquer screen on both or either of surfaces thereof. Thus certain patterns and grains are fabricated on both or either of the surfaces of the ceiling fan blades.

However, in this prior art method, ceiling fan blades are injection-shaped of plastic with certain sizes and shapes, and then are printed by heat or UV lacquer screen to generate certain patterns and grains on both or either of surfaces thereof. It is complicated that re-processing is necessary. Moreover, the printing method by heat or UV lacquer screen often leads to pedestrian patterns and grains. The ceiling fan blades are constrained of limited colors.

### SUMMARY OF THE INVENTION

Accordingly, an object of the present invention is to provide a method for fabricating ceiling fan blade, which lifts yield rate and reduces labor cost, and wherein the fabricated ceiling fan blades have diverse colors, and are novel, beautiful, bright and glazed.

The method for fabricating ceiling fan blade comprises the steps of punching, printing, drying, cutting, shaping and cooling. The step of punching includes choosing a film and then punching at least four positioning holes on the film. The step of printing includes printing a certain pattern on the film. The step of drying includes drying the film with infrared to form a film carrier. The step of cutting includes cutting the film carrier in accordance with desired sizes and shapes. The step of shaping includes placing the cut film carrier in an injection mold, and injection-shaping a shrouding block on a surface of the cut film carrier, the shrouding block enveloping a peripheral of the cut film carrier. The step of cooling includes cooling the shaped film carrier and forming a ceiling fan blade.

### BRIEF DESCRIPTION OF THE DRAWINGS

FIG. 1 is a flow chart of a method for fabricating ceiling fan blade according to the present invention.

FIG. 2 schematically shows a step of punching according to the present invention.

FIG. 3 schematically shows a step of drying according to the present invention.

FIG. 4 schematically shows a step of cutting according to the present invention.

FIG. 5 schematically shows a step of shaping according to the present invention.

FIG. 6 shows a plane view of the fabricated ceiling fan blade according to the present invention.

### DETAILED DESCRIPTION OF THE PREFERRED EMBODIMENTS

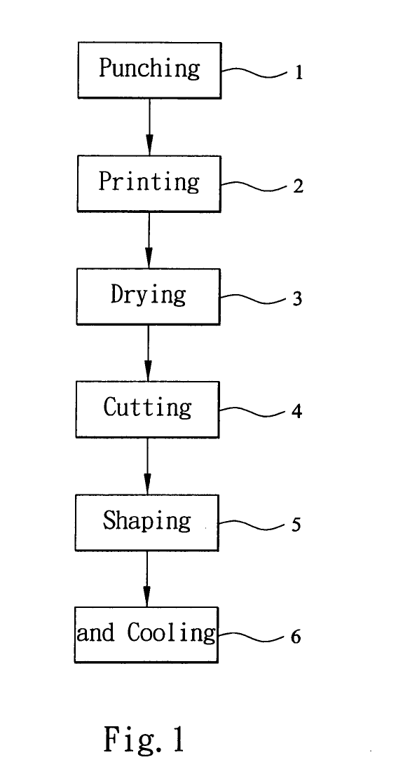

FIG. 1 is a flow chart of a method for fabricating ceiling fan blade of the present invention. The method comprises the following steps: punching 1, printing 2, drying 3, cutting 4, shaping 5 and cooling 6.

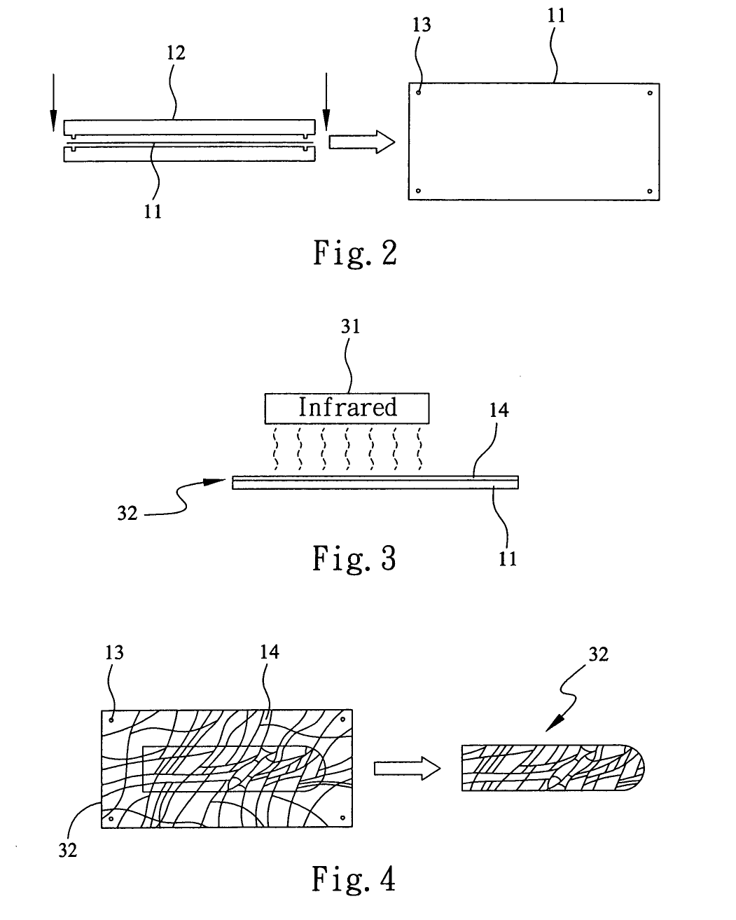

Punching 1: Further referring to FIG. 2, choosing a film 11, for example, the film 11 being Poly Carbonate PC film, and then punching at least four positioning holes 13 on the film 11 by an oil-pressure machine.

Printing 2: Printing a certain pattern 14 on the film 11 with the positioning holes 13 thereon by a four-color printing press.

Drying 3: Drying the film 11 with infrared 31 to form a film carrier 32, as shown in FIG. 3.

Cutting 4: Cutting the film carrier 32 in accordance with desired sizes and shapes by an oil-pressure machine, as shown in FIG. 4.

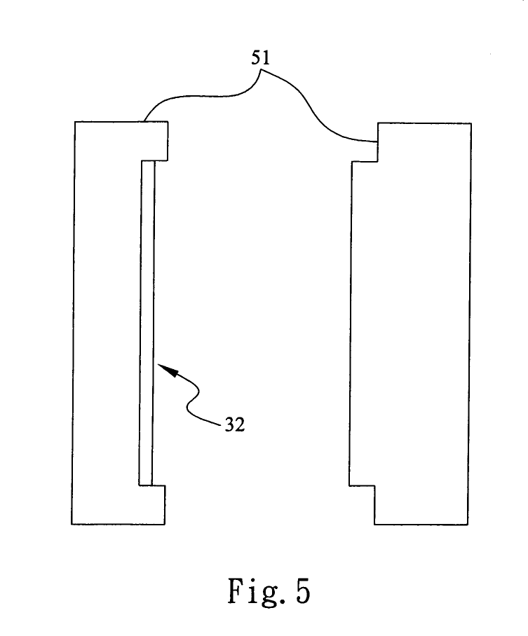

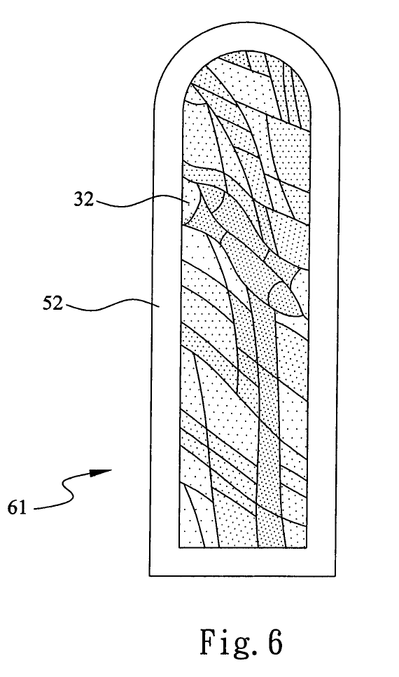

Shaping 5: Referring to FIGS. 5 and 6, placing the cut film carrier 32 in an injection mold 51, and injection-shaping a shrouding block 52 on a surface of the cut film carrier 32, the shrouding block 52 enveloping a peripheral of the cut film carrier 32.

Cooling 6: Cooling the shaped film carrier 32, and forming a ceiling fan blade 61.

The method for fabricating ceiling fan blade of the present invention overcomes deficiencies of prior art, and raises yield rate and reduces labor cost. On the other side, the fabricated ceiling fan blades take on diverse colors like colored glaze, and are novel, bright and beautiful.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A method for fabricating ceiling fan comprising steps of:
a) punching: choosing a film, and then punching at least four positioning holes on the film;
b) printing: printing a certain pattern on the film;
c) drying: drying the film with infrared to form a film carrier;
d) cutting: cutting the film carrier in accordance with desired sizes and shapes;
e) shaping: placing the cut film carrier in an injection mold, and injection-shaping a shrouding block on a surface of the cut film carrier, the shrouding block enveloping a peripheral of the cut film carrier; and
f) cooling: cooling the shaped film carrier, and forming a ceiling fan blade.

2. The method for fabricating ceiling fan as claimed in claim 1, wherein the film is Poly Carbonate (PC) film in the step of punching.

3. The method for fabricating ceiling fan as claimed in claim 1, wherein a four-color printing press prints a certain pattern on the film in the step of printing.

4. The method for fabricating ceiling fan as claimed in claim 1, wherein the film is dried with infrared in the step of drying.

5. The method for fabricating ceiling fan as claimed in claim 1, wherein the film carrier is cut by an oil-pressure machine in the step of cutting.

6. The method for fabricating ceiling fan as claimed in claim 1, wherein an oil-pressure machine punches the positioning holes on the film in the step of punching.
